(19) United States
(12) Patent Application Publication
(10) Pub. No.: US 2014/0003037 A1
(43) Pub. Date: Jan. 2, 2014

(54) BOTTLE CAP LED INSERT

(71) Applicants: Christopher J. Kuelzow, Rumson, NY (US); Thomas E. Dobyns, Columbia, MD (US); Christopher B. Dobyns, Highland, MD (US)

(72) Inventors: Christopher J. Kuelzow, Rumson, NY (US); Thomas E. Dobyns, Columbia, MD (US); Christopher B. Dobyns, Highland, MD (US)

(21) Appl. No.: 13/933,755

(22) Filed: Jul. 2, 2013

Related U.S. Application Data
(60) Provisional application No. 61/667,114, filed on Jul. 2, 2012.

(51) Int. Cl. F21V 33/00

(52) U.S. Cl. CPC F21V 33/0024
USPC 362/101

(57) ABSTRACT

A lighting apparatus includes a bottle comprising a top portion, a bottom portion, and an interior space in between, a grommet seated on and protruding out of the top portion, a bottom of the grommet coupled to a top portion of a heat sink, the heat sink embodied within the interior space, an LED coupled to a bottom portion of the heat sink, and a conductor coupled to the heat sink and extending through the grommet to an outside of the interior space.

This application claims priority from U.S. Provisional Patent Application No. 61/667,114, filed Jul. 2, 2012, the entire contents of which are incorporated herein by reference.

Disclosed is a light emitting diode (LED) light assembly which will replace the cap of a standard plastic bottle being used as a light-fixture. The embodiments of the present invention build upon the known method of producing indoor illumination during sunlight hours, whereby approximately three-fourths of a bottle, such as a standard plastic soda or water bottle, containing water and bleach, is inserted through a dwelling roof, while the remaining part of the bottle is exposed to sunlight on the outer portion of the roof. The water in the bottle carries the light through the bottle and provides light inside the dwelling during sunlight hours. The known method is used in regions of the world where electricity or access to electricity is scarce or non-existent.

However, when there is little or no sunlight, such as during evenings, nighttime, or in overcast conditions, the known method is not to able provide illumination. Accordingly, there is a need for a device and method that is capable of providing illumination during conditions where there is little or no external light.

The device according to embodiments of the present invention, delivers a diffuse high efficiency source of light during periods of little or no light, such as during nighttime hours. The device is designed to be inexpensive, and can be powered from manifold renewable energy sources, such as, for example, solar, etc., thus enabling broad application. Suitable for extreme conditions, the product utilizes recycled bottles as light fixtures, and will enable populations with minimal or no electricity access to light 24-hours a day for minimal cost, representing a substantial discount from the financial and social costs associated with alternatives, such as kerosene.

The above and other features of the present invention will become more apparent by describing in more detail exemplary embodiments thereof with reference to the accompanying drawings in which:

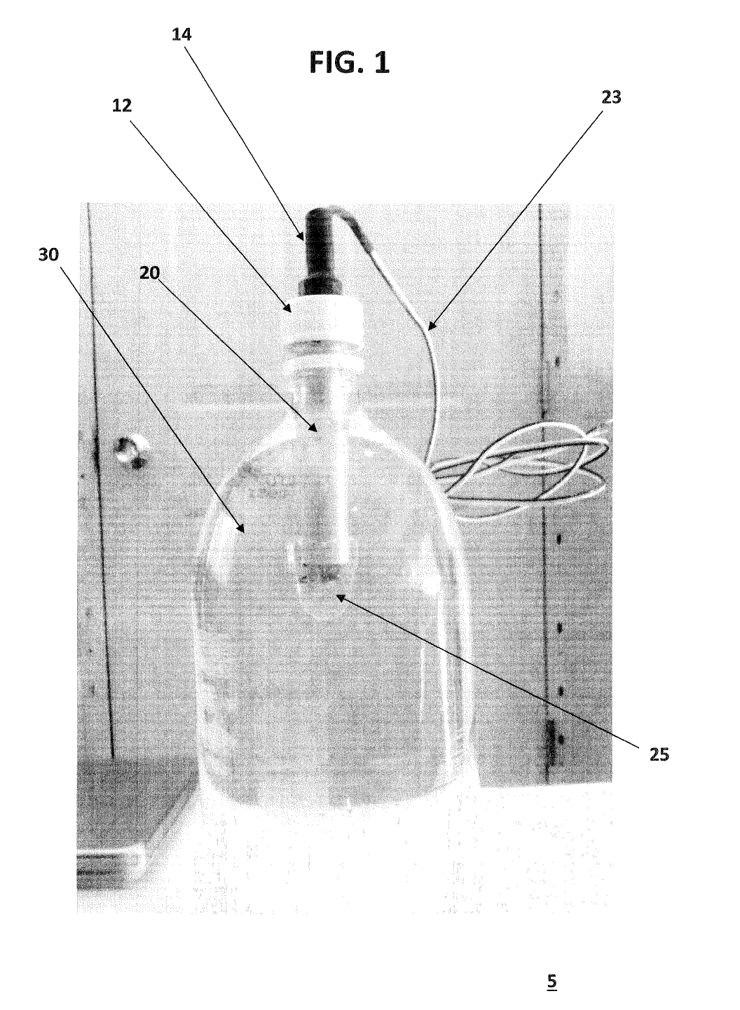

FIG. 1 is an image of the LED insert and bottle, according to an embodiment of the present invention;

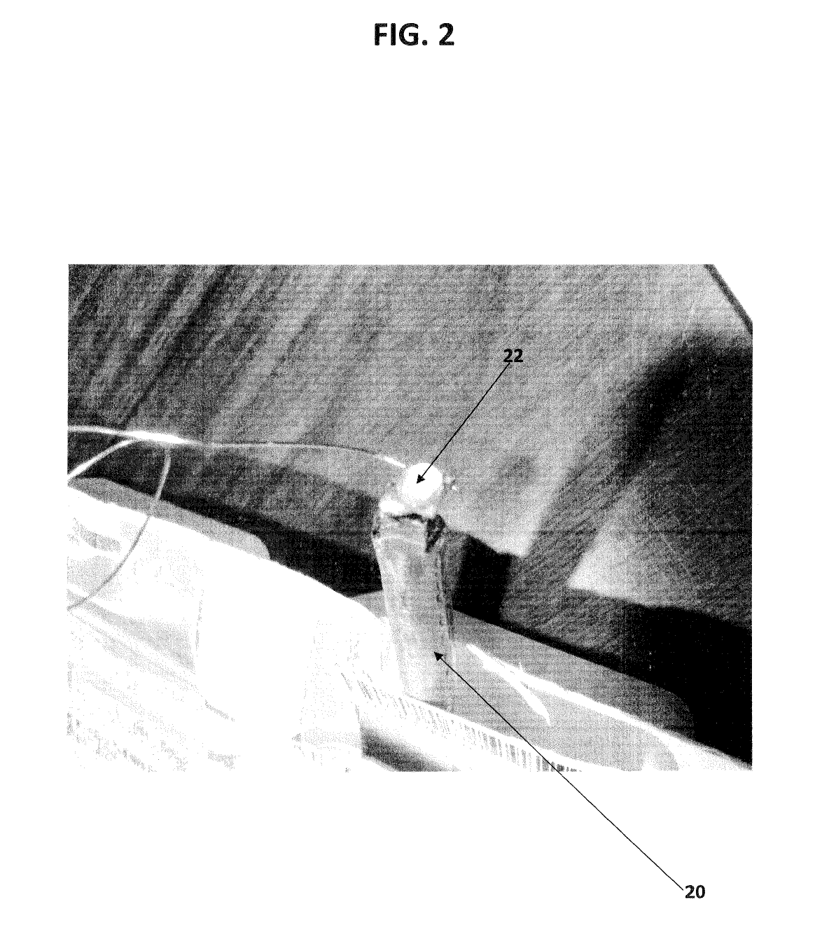

FIG. 2 is an end perspective view of the LED and heat-sink structure, according to an embodiment of the present invention;

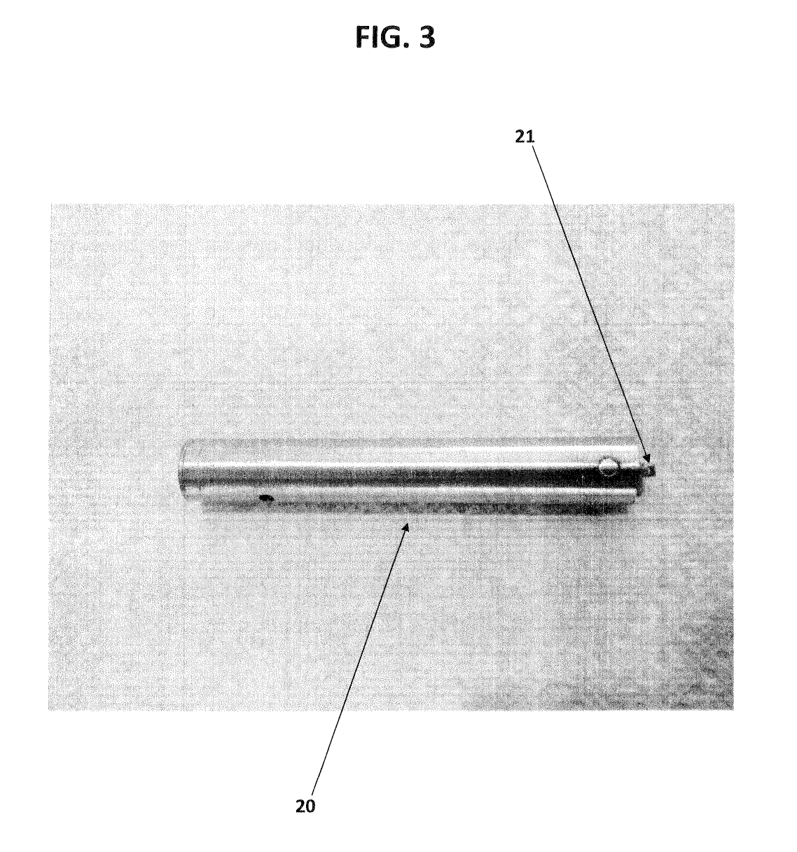

FIG. 3 is a side view of the heat sink structure, according to an embodiment of the present invention;

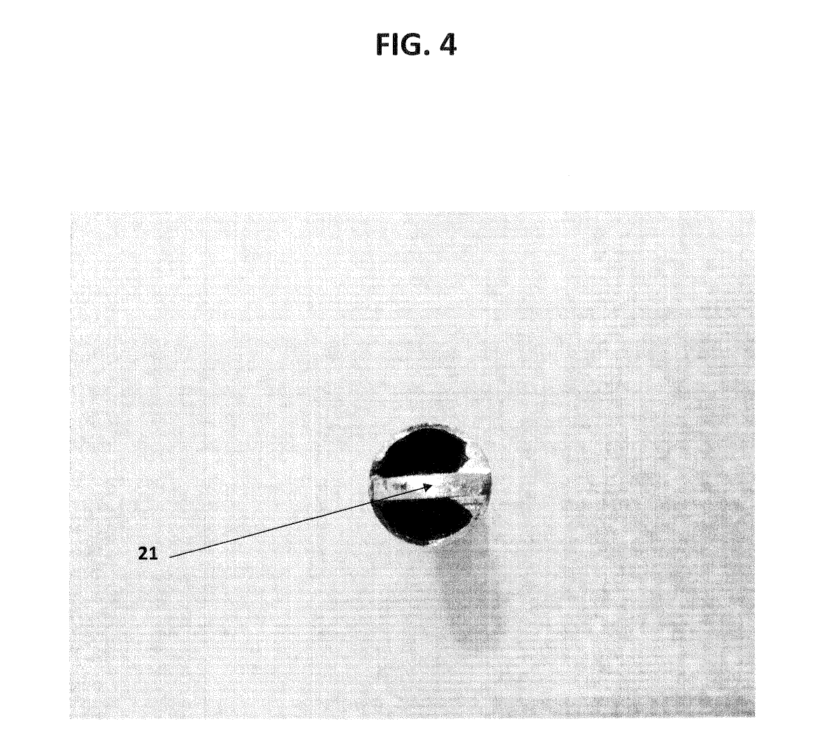

FIG. 4 is an end view of the heat sink structure, according to an embodiment of the present invention;

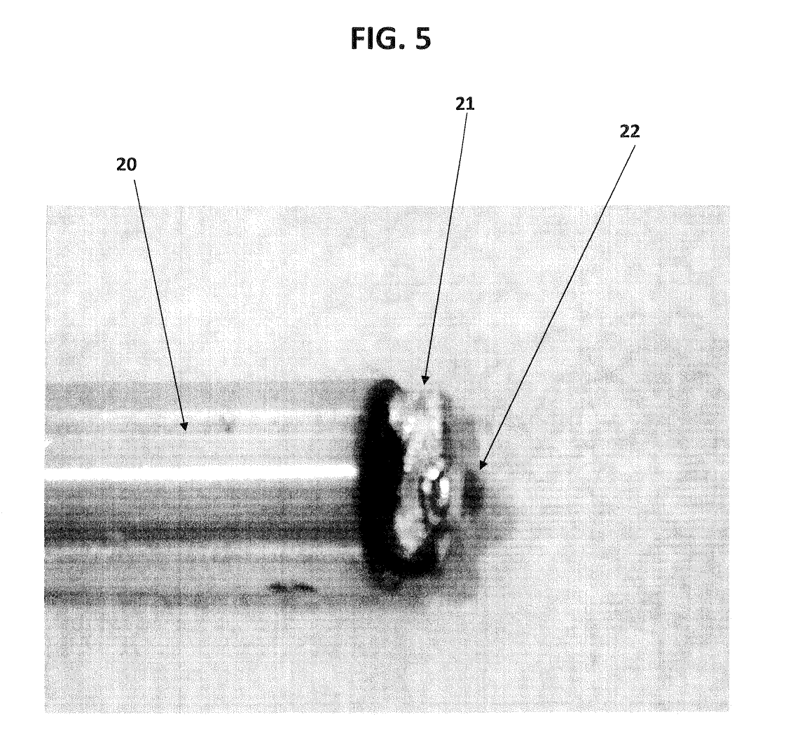

FIG. 5 is a close-up view of the LED attached to the heat sink structure, according to an embodiment of the present invention;

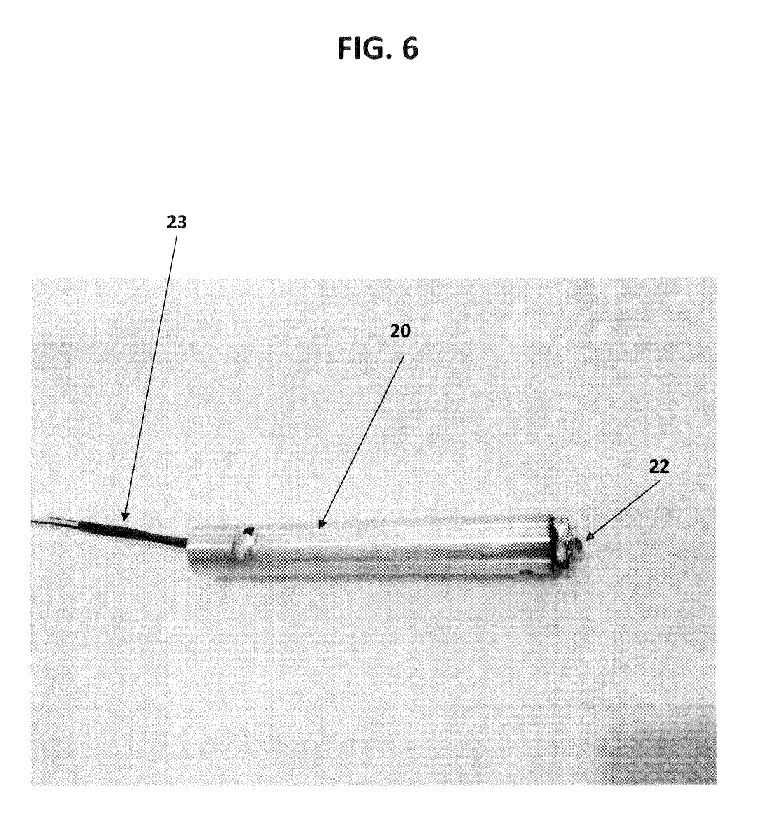

FIG. 6 is a side view of the LED and heat sink structure in a wired and assembled state, according to an embodiment of the present invention;

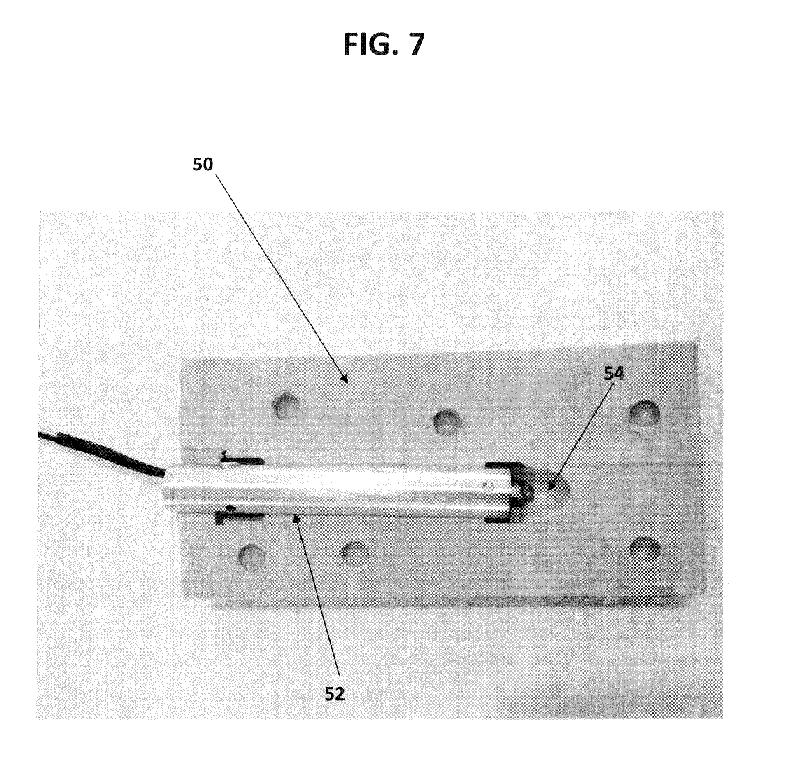

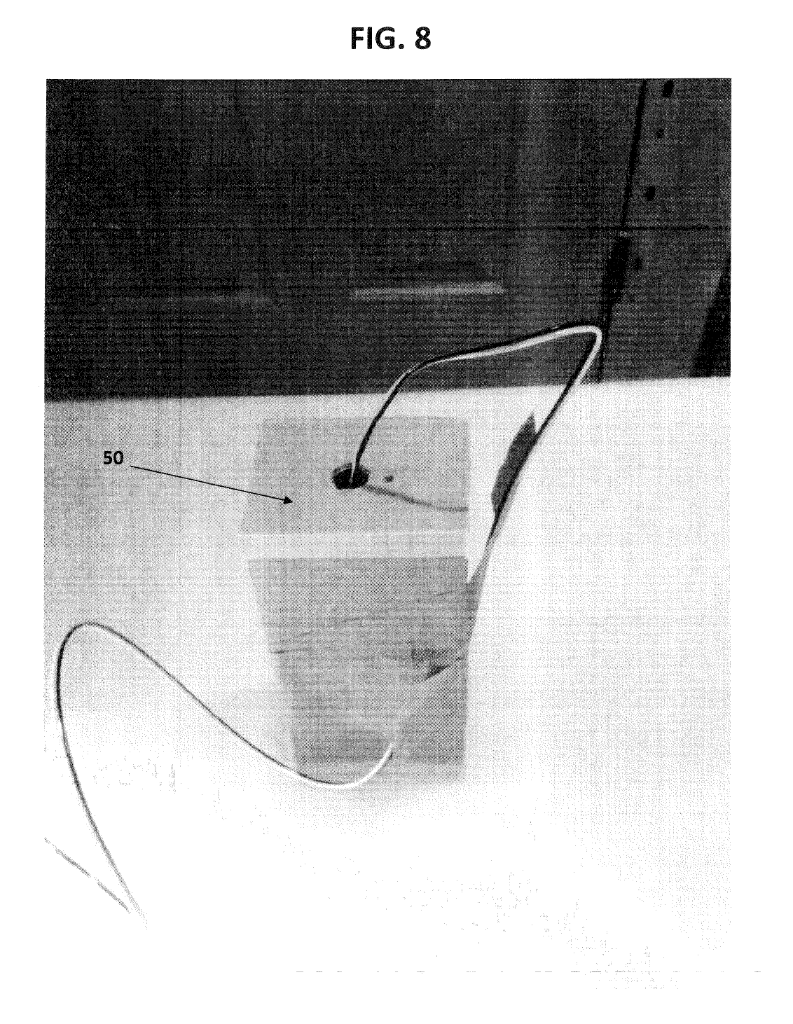

FIGS. 7 and 8 are images showing a method of manufacturing the LED insert, according to an embodiment of the present invention;

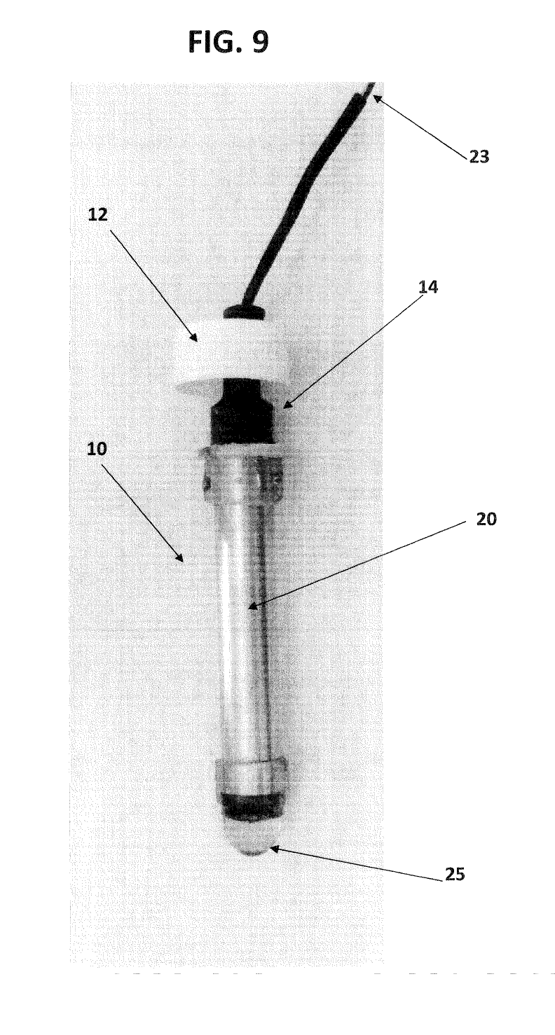

FIG. 9 is an image showing the LED insert including the heat sink structure after a casting process, according to an embodiment of the present invention;

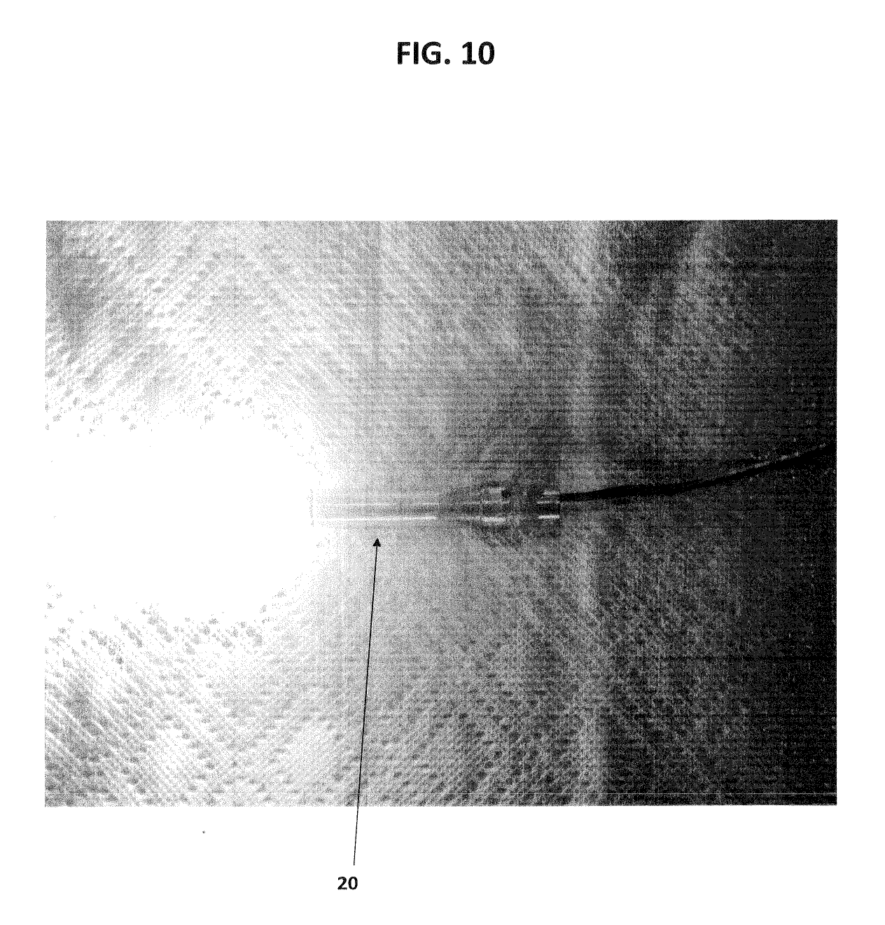

FIG. 10 is an image showing the LED insert including the heat sink structure after a casting process, showing the LED powered on, according to an embodiment of the present invention; and

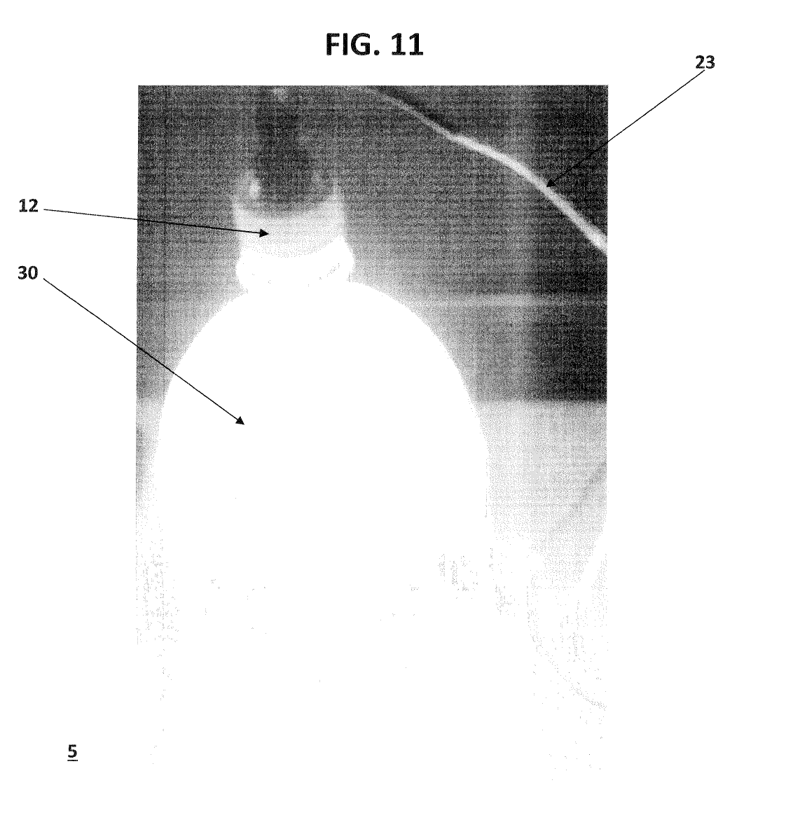

FIG. 11 is an image of the LED insert and bottle, showing the LED powered on, according to an embodiment of the present invention.

The lighting device 5, according to embodiments of the present invention, is intended to enhance the benefits of roof penetrating bottles currently repurposed for daytime lighting, by illuminating the same bottles at night.

According to an embodiment, as the light source, light emitting diode (LED) light sources are used, providing necessary performance, longevity, efficiency and ruggedness. For example, high efficiency CREE brand LEDs, such as the XLamp XM-L LED family w/100 lumens per watt efficacy, can be used. According to embodiments of the present invention, the selected LED can exceed the light output of an incandescent 40 watt bulb, and operate at a maximum drive current of 2000 mA for designs seeking the ENERGY STAR 35,000 hour lifetime rating (≧94.1% luminous flux @6000 hours) or 25,000-hour lifetime rating (≧91.8% luminous flux @6000 hours). However, the embodiments of the invention are not limited thereto, and other suitable light sources may be used depending on desired specifications and operating conditions.

Referring to the figures, an LED insert 10 is coupled to a cap 12 of a bottle 30. The LED insert 10 includes a transparent or semi-transparent dome like cover/lens 25 coupled to a leading end of a heat sink structure 20. The light source, such as an LED 22, is coupled (e.g., soldered) to the leading end of the heat sink structure 20 and is positioned under the cover/lens 25. The cover/lens 25 creates a watertight or waterproof seal with the heat sink structure 20, so that the LED 22 under the cover/lens 25 does not get wet if a leading portion of the heat sink structure 20 is immersed in a liquid, such as water. According to an embodiment, the bottle 30 may be filled with a liquid covering at least part of the heat sink structure 20 and the cover/lens portion 25.

In order to increase the life of the LED 22, the embodiments of the invention incorporate the heat sink structure 20 into the design of the lighting device 5. According to embodiments of the present invention, light-pipe air cooled and full or partial immersion liquid (e.g., water) cooled devices can be used.

According to an embodiment, the heat sink structure 20 may be fully or partially immersed in a liquid or air-cooled. In some situations, the liquid immersed device may be suited to the harsh environments typically expected in the target locations. However, as implemented, the immersion liquid cooled device's heat sink 20 is capable of operating outside a bottle in an air-cooled mode should that be required. For example, the device may be embodied as an air-cooled light pipe, as well as a direct immersion, liquid cooled device. According to an embodiment, a light source (LED for example) could be physically spaced apart from the inside of the bottle with a light pipe guiding the light into the bottle. For example, the device could have the LED on top of and outside of the bottle, but its light still transported via the light pipe into the bottle.

Referring to FIGS. 2-5, the LED 22 is soldered to a loop portion 21 at the leading end of the heat sink structure 20. The heat sink structure may be for example, copper, or other metal or material that is capable of removing heat from the LED 22. The body of the heat sink structure can be, for example, a hollow cylinder through which electrical wiring 23 extending from the LED 22 to a power source runs. However, the shape of the heat sink structure is not necessarily limited to a cylinder. The heat sink structure 20 should have a predetermined length necessary for removing a specified amount of heat from the LED 22. Referring to, for example, FIGS. 1, 6 and 9, the wiring 23 extends out of a top of the heat sink structure 20 and runs to a power source. According to an embodiment, the power source can be, for example, a solar powered circuit, which automatically activates under low light conditions, or a rechargeable battery source, rechargeable by, for example, solar energy, or by direct or indirect attachment to a suitable power generating device.

Referring to FIGS. 1, 9 and 11, the LED insert 10 is coupled to the underside of a cap 12 of the bottle 30. Coupling can be via a grommet 14 that fits in an opening in the cap 12. The grommet 14 can be, for example, rubberized or plastic, so as to protect the wiring 23, which runs through the grommet 14, from weather elements or impact. The grommet 14 can be adhered to the cap 12, using, for example, glue.

Referring to FIGS. 7 and 8, images of a casting method for manufacturing the LED insert 10 are shown, according to an embodiment of the present invention. As shown in FIG. 7, the heat sink structure 20, including the LED 22 already attached thereto and wiring 23 running through the heat sink structure from the LED 22, is placed in a mold 50. The mold 50 includes a first hollowed-out portion 52 for the heat sink structure 20, and a second hollowed-out portion 54 for the cover/lens 25. As can be seen part of the second hollowed-out portion 54 surrounds the heat sink structure 20 so that part of the liquid used to create the cover/lens 25 hardens around and is coupled to the heat sink structure 20 to create the watertight or waterproof seal.

Once the mold 50 is sealed, with the heat sink structure 20 therein, as shown in FIG. 8, a liquid, such as liquid polyurethane or injectable thermoplastic, is poured through the top hole in the mold and in the heat sink structure 20. The liquid travels through the heat sink structure 20 and out of the leading end of the heat sink structure 20 to collect in the second hollowed-out portion 54. A predetermined amount of the liquid is poured to adequately form the cover/lens portion 25. After pouring, the liquid hardens, thereby creating the cover/lens 25 coupled to the leading end of the heat sink structure 20, and sealing the LED 22 therein.

Referring to FIGS. 10 and 11, the LED insert 10 is placed in the bottle 30 with the leading end of the heat sink structure 20 including the cover/lens 25 going inside the bottle 30 and being immersed in the liquid therein. Once the LED 22 is powered on, light is projected downward into the bottle 30 to light up the bottle like a light bulb.

According to an alternative embodiment, a grommet sits on the top portion of the bottle and is coupled to the bottle. The coupling of the grommet to the bottle forms a watertight seal. A top portion of a heat sink is coupled to a bottom portion of the grommet. A light source, such as an LED, is coupled to a bottom portion of the heat sink and the light source is embodied within an interior space of the bottle. A conductor, such as a wire, is coupled to the heat sink and extends through the grommet to an outside of the bottle. The conductor is connected to a power source.

It is to be understood that material and manufacturing operation changes within the scope of the embodiments of the invention that would best deliver a low cost, high value device in large quantities are contemplated. For example, in the manufacture of a device according to embodiments of the present invention, any combination of techniques suitable to mass production, such as injection molding, sonic welding of pre formed components, or the like, can be implemented.

Although exemplary embodiments of the present invention have been described hereinabove, it should be understood that the present invention is not limited to these embodiments, but may be modified by those skilled in the art without departing from the spirit and scope of the present invention.

What is claimed is:

1. A lighting apparatus comprising:
a bottle comprising a top portion, a bottom portion, and an interior space in between;
a grommet seated on and protruding out of the top portion;
a bottom of the grommet coupled to a top portion of a heat sink, the heat sink embodied within the interior space;
an LED coupled to a bottom portion of the heat sink; and
a conductor coupled to the heat sink and extending through the grommet to an outside of the interior space.

2. The lighting apparatus of claim 1, wherein the bottle contains a liquid.

3. The lighting apparatus of claim 2, wherein the liquid comprises bleach.

4. The lighting apparatus of claim 1, wherein the heat sink comprises a metal.

5. The lighting apparatus of claim 4, wherein the metal is copper.

6. The lighting apparatus of claim 1, wherein the grommet is coupled to the bottle in a watertight seal.

7. The lighting apparatus of claim 1, further comprising a power source.

8. The lighting apparatus of claim 7, wherein the power source comprises a battery.

9. The lighting apparatus of claim 8, wherein the battery is adapted for capturing solar energy.

10. The lighting apparatus of claim 1, wherein the grommet comprises a rubber.

11. The lighting apparatus of claim 1, wherein the grommet comprises a plastic.

12. The lighting apparatus of claim 1, further comprising a cap having a hole, the cap coupled to the top portion.

13. A lighting apparatus comprising:
a bottle comprising a top portion, a bottom portion, and an interior space in between;
a cap having a hole, the cap coupled to the top portion;
a grommet protruding out of the top portion;
a bottom of the grommet coupled to a top portion of a heat sink, the heat sink embodied within the interior space;
an LED coupled to a bottom portion of the heat sink; and
a wire coupled to the heat sink and extending through the grommet to an outside of the interior space.

14. The lighting apparatus of claim 13, wherein the bottle contains a liquid.

15. The lighting apparatus of claim 14, wherein the liquid comprises bleach.

16. The lighting apparatus of claim 13, further comprising a power source.

17. The lighting apparatus of claim 16, wherein the power source comprises a battery.

18. The lighting apparatus of claim 17, wherein the battery is adapted for capturing solar energy.

19. The lighting apparatus of claim 13, wherein the grommet comprises a rubber.

20. The lighting apparatus of claim 13, further comprising a light pipe coupled to a top of the cap, the light pipe configured to direct light through the hole and into the interior space.
